(19) United States
(12) Patent Application Publication
(10) Pub. No.: US 2019/0170047 A1
(43) Pub. Date: Jun. 6, 2019

(54) STOP VALVE, SCR SYSTEM, AND METHOD FOR DETECTING LEAKS AND/OR IDENTIFYING VARIATIONS IN METERED AMOUNTS

(71) Applicant: Robert Bosch GmbH, Stuttgart (DE)

(72) Inventors: Okke VENEKAMP, Stephanskirchen (DE); Chen ZHOU, Benningen Am Neckar (DE); Simon Michael HEITZER, Kolbermoor (DE)

(21) Appl. No.: 16/302,250

(22) PCT Filed: Mar. 24, 2017
(86) PCT No.: PCT/EP2017/057079

§ 371 Date: Nov. 16, 2018

(30) Foreign Application Priority Data
May 19, 2016 (DE) 10 2016 208 611.1

(51) Int. Cl. F01N 11/00; F16K 31/126; F16K 37/00; G01M 3/28; F16K 31/06; F01N 3/20

(52) U.S. Cl. CPC F01N 11/00; F16K 31/1262; F16K 37/0091; G01M 3/28; F16K 31/0672; F01N 2900/0412; F01N 2550/05; F01N 2560/08; F01N 2610/01; F01N 2610/144; F01N 3/2066

(57) ABSTRACT

Disclosed is a stop valve (100) comprising a magnetic yoke (101), a solenoid coil (102), a compression spring (107) and an armature (105) on which an elastic membrane (106) is arranged. The membrane (106) can be sealingly pressed onto at least one fluid connection (108, 109). The stop valve (100) further comprises a guide (111) and a guide pin (110) that is connected to the armature (105). Finally, the compression spring (107) is positioned in such a way as to surround the solenoid coil (102). Also disclosed is a method for detecting leaks and/or identifying variations in metered amounts. Said method, which is carried on in an SCR system comprising the stop valve (100), involves opening the stop valve (100), whereupon a pressurized line is filled with a reducing agent and the stop valve (100) is closed. A pressure is subsequently lowered upstream of the stop valve (100) by shutting off a pump. Finally, any leak is detected and/or variations in the metered amount are identified by having the pressure sensor monitor the pressure downstream

### BACKGROUND OF THE INVENTION

The present invention relates to a stop valve. Moreover, the invention relates to an SCR system which comprises this stop valve and to a method for detecting leaks and/or identifying variations in metered amounts in said SCR system. Furthermore, the present invention relates to a computer program which carries out each step of the method when it runs on a computing device, and to a machine-readable storage medium which stores the computer program. Finally, the invention relates to an electronic control device which is configured to carry out the method.

Stop valves are used to control fluid movements. In an open state, they determine the direction of flow of a fluid and, in a closed state, they prevent the movement of the fluid. Nowadays, stop valves are used in SCR systems to control a movement of a reducing agent (AdBlue®). In particular, stop valves are arranged in a pressure line of the SCR system between a feed module and a metering module. There, the aim is to prevent leakage of the reducing agent into the pressure line since otherwise there is the possibility that this reducing agent will freeze and damage sensitive components.

One example of a stop valve as described above is given in DE 10 2011 090 070 A1. This relates to a stop valve which is used in an SCR system. This is a 2/2-way valve, in which a diaphragm plunger is pressed onto a diaphragm by means of a diaphragm spring. The open state is achieved by means of a solenoid coil and it can then automatically remain open once the minimum pressure in the through flow direction has been achieved in the system. In the closed state or with the diaphragm plunger closed, the stop valve prevents leakage.

DE 10 2012 204 104 A1 likewise relates to a stop valve, which is arranged in a device for admitting air to an exhaust gas aftertreatment system. Here, the stop valve is arranged in a feed line between the feed module and the metering module. The 2/2-way valve is actuated hydraulically by means of an actuator, and therefore there is no need for a magnet here. Branching off from the feed line there is a control line, which is used to control the actuator. If there is then excess pressure prevailing in the feed line in the feed mode, the actuator is activated and opens the valve.

Furthermore, DE 10 2012 211 112 A1 relates to a stop valve which is used in an SCR system. In this system, the switchover between the feed mode and the return mode is achieved by means of an additional switching valve. This stop valve comprises a shuttle valve and a 2/2-way valve. The shuttle valve opens the 2/2-way valve at two different pressure levels. This has the result that the stop valve can be opened both in the feed mode and in the reverse suction mode.

DE 10 2012 209 689 A1 relates to an arrangement for exhaust gas aftertreatment by means of SCR. In this document, a feed module and a stop valve are described. The stop valve prevents leakage by means of a shutoff element. This is achieved by means of a sealing plunger which, in the closed state, rests leaktightly on the sealing seat. The open state is achieved with the aid of a bistable spring element, which presses the sealing plunger with a low holding force against the contact surface. Here, the bistable spring element ensures a high closing force and a low holding force. This enables the valve to be used without active control, and therefore the valve in this arrangement is preferably used in a passive way.

### SUMMARY OF THE INVENTION

The proposal is for a stop valve which is configured to control a fluid movement. In particular, the stop valve is intended to prevent a movement of the fluid and leakage when it adopts a blocking mode. For this purpose, it comprises a magnet yoke, a solenoid coil and a compression spring. The stop valve furthermore comprises a guide and a guide pin, which is inserted into the guide. The guide is connected to a magnet armature, on which a flexible diaphragm is arranged, wherein the diaphragm can be sealingly pressed onto at least one fluid connection. The compression spring is arranged in such a way as to surround the solenoid coil and optionally the magnet armature. In particular, it is possible in this case for the magnet armature to be embodied as a flat armature or as a plunger.

The guide can be configured in different ways, depending on the illustrative embodiment. In one version, guide bushes, into which the guide pin is inserted, are formed within the solenoid coil. As an alternative, it is also possible for sliding bearing bushes or a sliding bearing layer to be formed on an intermediate washer, the magnet armature rubbing along these sliding bearing bushes or this sliding bearing layer and thereby being guided. In order to ensure the maximum possible durability, the sliding bearing bushes or sliding bearing layer are preferably produced from nickel or other, harder coatings, and the magnet armature is preferably produced from magnetic stainless steel. In addition, the magnet armature is preferably supported by the guide pin. The guide has the advantage that transverse forces which act on the magnet armature can be compensated.

Another aspect of the invention relates to a transfer of thermal energy from the solenoid coil to a fluid connection. The guide can be designed in such a way that it rests on the magnet yoke. Thus, heat transfer surfaces are formed, via which thermal energy can be transferred from the solenoid coil to the guide pin. Since the guide is likewise connected to the magnet armature, the thermal energy can be transmitted via the diaphragm to the fluid connection. As a consequence, the guide offers an additional advantage since it contributes to the thawing process of a fluid in the fluid connection or to the anti-freezing protection thereof.

According to one aspect, the stop valve is used in an SCR system. The SCR system comprises a pump in a feed module and a metering module, which are connected to one another by a pressure line. The stop valve described above is arranged in the pressure line. Furthermore, the pressure line comprises a pressure sensor, which is arranged between the stop valve and the metering module. This SCR system has the advantage that it prevents basic leakage through pump gaps in a pump which can deliver and return fluid by reversal of the direction of rotation.

The stop valve is preferably configured in such a way that it can adopt the following modes. In a blocking mode, the diaphragm is pressed onto both a fluid inlet and a fluid outlet by the magnet armature and closes them in a leaktight manner. This offers the advantage that, in the blocking mode, the stop valve ensures shutoff against a reduced pressure and an excess pressure both from the fluid inlet and from the fluid outlet. A metering mode is furthermore provided, in which the stop valve is opened hydraulically in a deenergized condition above a defined pressure and remains open by virtue of the pressure. As a result, active control is not necessary in a metering mode of the SCR system. Moreover, a reverse suction mode is provided, in which a magnetic force between the magnet yoke and the magnet armature holds the stop valve in an open position. This enables a reducing agent to be sucked back out of the pressure line of the SCR system.

Another aspect of the stop valve relates to ice pressure protection of the SCR system. The freezing reducing agent leads to an ice pressure, which can lead to displacement of a volume. The diaphragm can be pushed in the direction of the valve interior at the fluid inlet without the stop valve allowing fluid flow. An ice pressure displacement volume is defined thereby.

The method for detecting leaks and/or identifying variations in metered amounts is used in the SCR system describe above, including the stop valve. Here, the method comprises the following steps: first of all, the stop valve opens, enabling the pressure line to be filled with reducing agent. After this, the stop valve is closed, and a pressure downstream of the stop valve, i.e. between the stop valve and the metering valve, is enclosed in the pressure line. The enclosed pressure is monitored by the pressure sensor. A pressure upstream of the stop valve, i.e. between the stop valve and the feed module, is then lowered by shutting off the pump. In a further step, leak detection and/or identification of variations in metered amounts can be carried out by exploiting the fact that, as described above, the pressure downstream of the stop valve is being monitored by means of the pressure sensor.

As an option, the stop valve can be closed by the spring force of the compression spring. This offers the advantage that the stop valve is closed automatically and remains closed without the need for a power supply. The compression spring can additionally apply a force to press the diaphragm against a fluid inlet and a fluid outlet when the pressure upstream of the stop valve is lowered. Simultaneous closure of both openings is thereby achieved. This has the effect that neither the reduced pressure attributable to the pump upstream of the stop valve nor the excess pressure due to the enclosed pressure downstream of the stop valve leads to opening of the stop valve. Moreover, it is not necessary to supply the stop valve with power during leakage detection and/or identification of variations in metered amounts.

According to one aspect, a first pressure can be built up in the system during the filling of the pressure line with reducing agent. In particular, this is in a range of from 5.8 bar to 10 bar. The pressure is then reduced to a second pressure, which is, in particular, between 2 bar and 5.5 bar, whereupon the stop valve closes. This ensures that the pressure equalizes throughout the SCR system. The pressure drop can be achieved, for example, by means of a restrictor or a check valve, which connects a return to a section of the pressure line upstream of the stop valve.

The second pressure is thus enclosed in the pressure line between the stop valve and the metering module and can be used to detect leaks and/or identify variations in metered amounts. The pressure upstream of the stop valve is then lowered by the pump to a third pressure, between 1 bar and 2 bar. This leads to a pressure difference between the fluid inlet and the fluid outlet of the stop valve, which causes the stop valve to close.

Leakage detection is preferably performed by the pressure sensor detecting the enclosed pressure downstream of the stop valve (second pressure) over a defined time period of 0.5 to 30 seconds. If the enclosed pressure changes during this time period, it is possible to infer a leak in the pressure line or in the metering module.

Once leakage detection and/or identification of variation in metered amounts is concluded, the pressure upstream of the stop valve, i.e. on the pump side, can be increased again to a fourth pressure. In particular, this can, in turn, be in a range of from 4.8 bar to 10 bar. The SCR system has thus been diagnosed and is ready for metering.

The computer program is configured to carry out each step of the method, especially if it is carried out on a computing device or control device. It allows the implementation of the method in a conventional electronic control device without having to make structural modifications to the latter. For this purpose, it is stored on the machine-readable storage medium.

Loading the computer program onto a conventional electronic control device gives the electronic control device which is configured to carry out leakage detection and/or identification of variation in metered amounts.

### BRIEF DESCRIPTION OF THE DRAWINGS

Illustrative embodiments of the invention are shown in the drawings and explained in greater detail in the following description.

FIG. 1 shows schematically a stop valve according to one embodiment of the invention.

FIG. 2 shows schematically a stop valve according to another embodiment of the invention.

FIG. 3 shows schematically a stop valve according to yet another embodiment of the invention.

FIG. 4 shows schematically an SCR system according to one embodiment of the invention.

FIG. 5 shows a flow diagram of one illustrative embodiment of the method according to the invention.

FIG. 6a shows a diagram of a pressure in a first section of the pressure line against time in an SCR system according to one illustrative embodiment of the invention.

FIG. 6b shows a diagram of a pressure in a first section of the pressure line against time in an SCR system according to one illustrative embodiment of the invention.

### DETAILED DESCRIPTION

FIG. 1 shows a stop valve 100 according to a first illustrative embodiment of the invention. It comprises a magnet yoke 101, which comprises a solenoid coil 102, which is held by a bobbin 103. The magnet yoke 101 and the bobbin 103, including the solenoid coil 102, are surrounded by a magnet shell 104. Moreover, the stop valve 100 comprises a flat armature 105, on which a flexible diaphragm 106 is arranged. Here, the diaphragm 106 is composed of HNBR (hydrogenated acrylonitrile butadiene rubber) and is sprayed or vulcanized onto the flat armature 105. The flat armature 105, in turn, is connected to one end of a compression spring 107 which surrounds the rim of the lateral surface of the flat armature 105. In another embodiment, a plunger can be used instead of the flat armature 105. Another end of the compression spring 107 is connected in such a way to the magnet yoke 101 that the compression spring 107 encloses within it the bobbin 103, including the solenoid coil 102. A fluid inlet 108 and a fluid outlet 109 are arranged in such a way that the diaphragm 106 can be pressed sealingly onto both and thus closes both.

Furthermore, the stop valve 100 comprises a guide pin 110, which is connected to the flat armature 105, and a guide bush 111, into which the guide pin 110 can be inserted. The guide bush 111 comprises two parts, which are arranged on a common line within the solenoid coil 102, along the coil axis thereof. In the open state of the stop valve, the guide pin extends beyond both guide bushes 111, as far as the edge of the magnet yoke 101. As a consequence, the guide pin 110 is held by the guide bush 111 in such a way that the pin can then only move along the axis of the compression spring 107. For this reason, the guide pin 110, together with the guide bush 111, acts as a guide for the flat armature 105.

Since the guide bush 111 is connected to the guide pin 110 and to the magnet yoke 101 and thus to the solenoid coil 102, thermal energy can be transferred between the solenoid coil 102 and the guide pin 110 via heat transfer surfaces. The thermal energy is then transferred onward, via the flat armature 105, to the diaphragm 106, which can release the thermal energy into the fluid connections 108 and 109, where it contributes to the thawing of a liquid, or protects the latter from freezing.

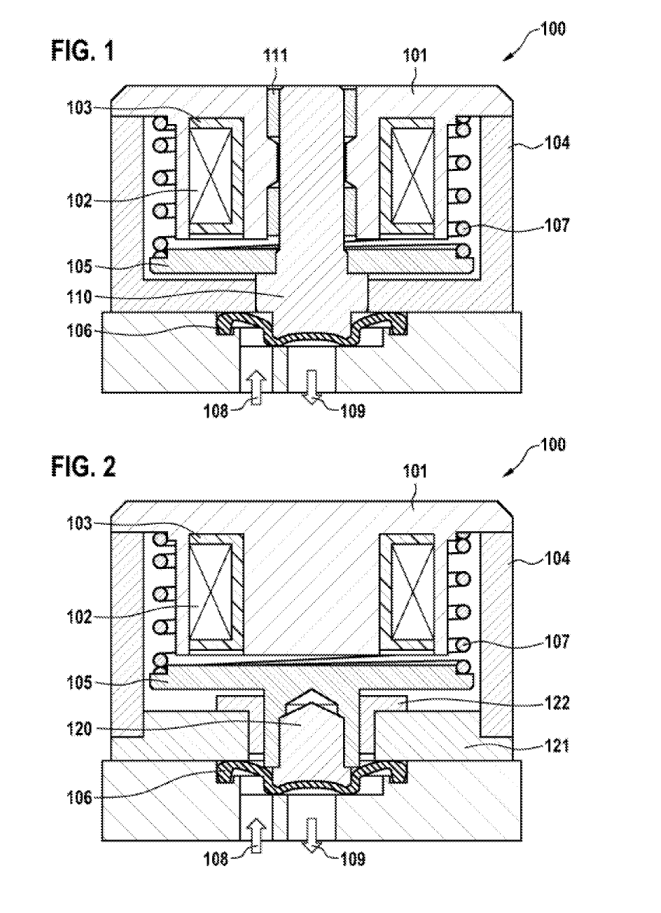

FIG. 2 shows a second illustrative embodiment of the stop valve 100 according to the invention. Apart from the guide elements, it comprises essentially the same components that have been described in FIG. 1 and these components have substantially the same function. They are therefore not described again. In this illustrative embodiment, a guide pin 120 is likewise connected to the flat armature 105. In another embodiment, this armature can be designed as a plunger. Here, the guide pin 120 extends from the diaphragm side of the stop valve 100 into the flat armature 105 and is surrounded by the latter, as a result of which it supports said armature. A sliding bearing bush 122 is arranged on an intermediate ring 121, which is arranged on the magnet shell 104. The flat armature 105 is guided by this sliding bearing bush 122 in that it rubs along the inside thereof. It should be noted that the guide pin 120 does not project into the interior of the solenoid coil 102, as in the first illustrative embodiment, but is essentially restricted to the length of the sliding friction bush.

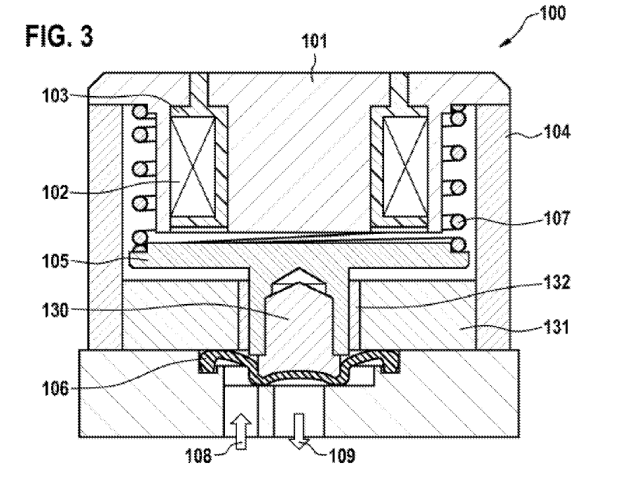

FIG. 3 shows a third illustrative embodiment of the stop valve 100 according to the invention. The third illustrative embodiment differs from the second illustrative embodiment in FIG. 2 only in the configuration of the guide. The identical components are therefore not described again. In the third illustrative embodiment, as in the second illustrative embodiment, a guide pin 130 is connected to the flat armature 105. In another embodiment, this armature can be designed as a plunger. Likewise, the guide pin 130 extends from the diaphragm side of the stop valve 100 into the flat armature 105 and is surrounded by the latter, as a result of which it supports said armature. Instead of the sliding bearing bush 122, a sliding bearing layer 132 is applied to an intermediate ring 131, which is arranged on the magnet shell 104. The flat armature then rubs along the sliding bearing layer 132 of the intermediate ring 131 and, as a consequence, is guided by said layer. Here too, the guide pin 120 does not project into the interior of the solenoid coil 102, as in the first illustrative embodiment, but is restricted essentially to the length of the sliding friction layer.

In the second and third embodiments, a suitable material is used for the sliding bearing bush 122 and the sliding bearing layer 132, respectively, and with this material a large number of strokes is possible without wear. In this case, nickel is used, which survives 0.1-10 million strokes. The flat armature 105 is ground or polished on the surface with which it rubs against the sliding bearing bush 122 or the sliding bearing layer 132.

Depending on condition or use, the stop valve 100 can adopt different modes. In a blocking mode, the compression spring 107 pushes the flat armature 105 in the direction of the fluid inlet 108 and the fluid outlet 109, with the result that the diaphragm 106 simultaneously closes both. The stop valve 100 is thus closed by the spring force of the compression spring 107, and no power supply is required. This eliminates the possibility of fluid flow through the stop valve. The spring force of the compression spring 107 also holds the stop valve closed when a reduced or excess pressure is present at the fluid inlet 108 and/or the fluid outlet 109, as long as this pressure is low enough, e.g. below 5.6 bar.

Another mode allows the fluid to flow from the fluid inlet to the fluid outlet. In this metering mode, the pressure p in the fluid inlet 108 pressing against the diaphragm 106 and thus against the flat armature 105 is such that it overcomes the spring force of the compression spring 107. As a result, the flat armature 105 is pushed in the direction of the magnet yoke 101, and there is a connection between the fluid inlet 108 and the fluid outlet 109. In the illustrative embodiment under consideration, this pressure p is 5.6 bar. In this mode, there is likewise no need for power to be supplied. The diaphragm opens with pressure assistance and, when the pressure p applied in the system is from 4 to 10 bar, does not allow any pressure loss.

Moreover, the stop valve 100 can adopt a reverse suction mode, in which the solenoid coil 102 is activated. This provides a magnetic force between the magnet yoke 101 and the flat armature 105, with the result that the flat armature 105 is pulled toward the magnet yoke 101 and the spring force of the compression spring 107 is overcome. During this process, a connection, through which fluid can flow, is established or maintained between the fluid outlet 109 and the fluid inlet 108.

Since the diaphragm 106 is flexible, it is possible to deform it. At the fluid inlet, it is therefore possible to push the diaphragm 106 into the interior of the stop valve, between the flat armature 105 and the magnet shell 104. However, the diaphragm 106 continues to close both the fluid inlet 108 and the fluid outlet 109 in the blocking mode. For this reason, only an additional volume is formed. This volume can be used when the fluid is a liquid which expands upon freezing, since it acts as an ice pressure displacement volume.

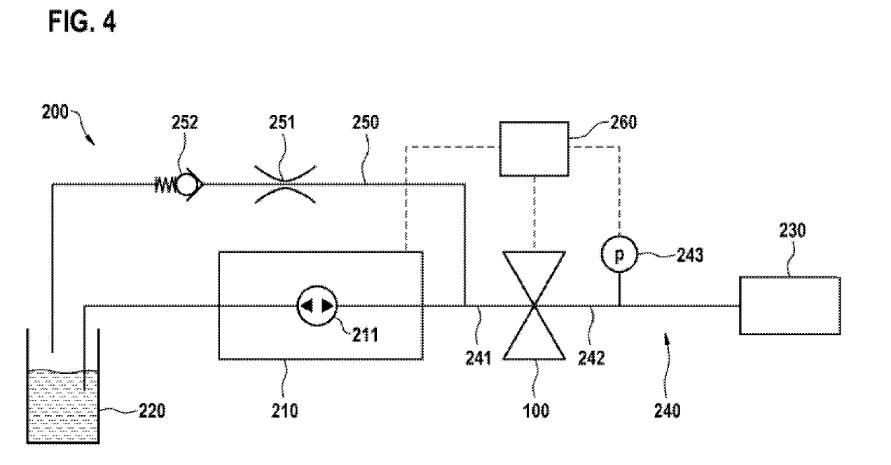

FIG. 4 shows an SCR system 200 which comprises the stop valve 100 according to the first, second or third illustrative embodiment. Furthermore, it comprises a feed module 210, which comprises a pump 211 configured to feed reducing agent out of a reducing agent tank 220 and to draw it back into the reducing agent tank 22 by means of a reversal of the direction of rotation. The feed module 210 is connected to a metering module 230 via a pressure line 240. The stop valve 100 is arranged in the pressure line 240 and divides it into two sections. A first section 241 of the pressure line 240 is situated upstream of the stop valve 100, between the latter and the feed module 210. A second section 242 of the pressure line 240 is situated downstream of the stop valve 100, between the latter and the metering module 230. Arranged in the second section 242 of the pressure line 240 there is furthermore a pressure sensor 243, which monitors the pressure p in the second section 242 of the pressure line 240 and optionally, when the stop valve 100 is open, likewise monitors it in the first section 241 thereof. Furthermore, the SCR system 200 comprises a return line 250, which connects the first section 241 of the pressure line 240 to the reducing agent tank 220. A return restrictor 251 and a check valve 252 are arranged in this return line 250. In another embodiment, the return restrictor 251 or the check valve 252 can be removed. The stop valve 100, the pressure sensor 243 and the feed module 210 are connected to an electronic control device 260, which controls them.

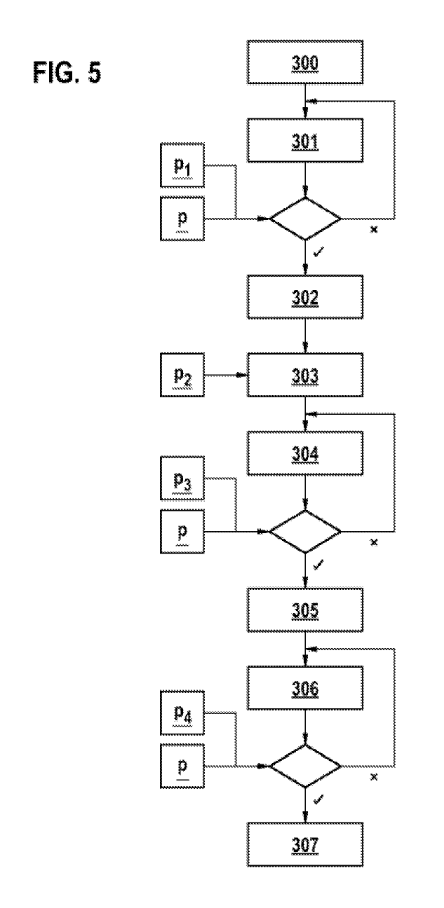

FIG. 5 illustrates a flow diagram of an illustrative embodiment of the method according to the invention for detecting leaks and/or identifying variations in metered amounts, as carried out in the SCR system 200. During the entire process, the metering module 230 remains closed. In a first step 300, the stop valve 100 opens. With the pump 211 switched on, filling 301 of the pressure line 240 with reducing agent takes place, as a result of which the pressure p in both parts 241 and 242 of the pressure line rises. When the pressure p in the entire pressure line 240 reaches a first pressure p₁, 7 bar, the pump 211 is switched off 302. As a consequence, the pressure p in the pressure line 240 falls. When the pressure p then reaches a second pressure p₂, 3.5 bar, the spring force of the compression spring 107 overcomes the pressure p, and the stop valve 100 closes 303. As a result, the second pressure p₂ is enclosed in the second section 242 of the pressure line 240. A further lowering 304 of the pressure p then takes place in the first section 241 of the pressure line 240, until a third pressure p₃, 1.5 bar, is reached.

There follows a further step 305, in which leak detection and/or identification of variations in metered amounts is/are carried out. In the case of leak detection, the pressure p₂ which is enclosed in the second section 242 of the pressure line 240 is observed over a predetermined time period of 10 seconds. If the pressure p falls during the observed time period, some of the fluid must be escaping through one of the components, namely the metering module 230, the pressure line 240, the stop valve 100 or connecting pieces situated between them. Since the stop valve 100 is configured to prevent leakage as far as possible, it is possible from this to detect a leak in the metering module 230 and/or the pressure line 240. From the pressure and the quantity of reducing agent supplied, it is furthermore possible to identify a deviation between the desired metered amount and the actual metered amount which is enclosed in the second section 242 of the pressure line 240.

Once leak detection and/or identification of variations in metered amounts is concluded, the pressure p in the first section 241 of the pressure line 240 is increased again in a further step 306 by switching the pump 211 on again. When the pressure p reaches a fourth pressure p₄, the stop valve 100 opens 307 again and the system has been diagnosed and is ready for metering.

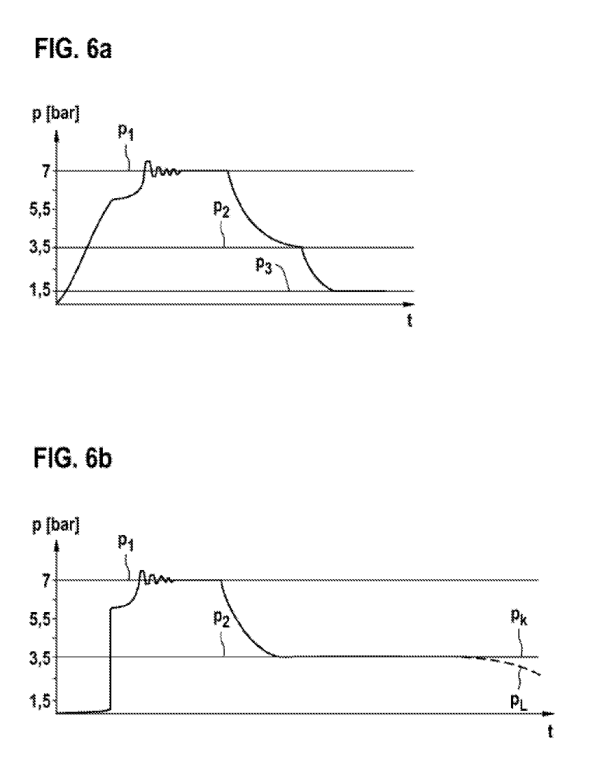

FIGS. 6a and 6b show diagrams which illustrate the pressure characteristic in the first section 241 and the second section 242 of the pressure line 240 against time t. The stop valve 100 opens 300 at a pressure p of 5.6 bar. In the time period between the opening 300 and the closing 303 of the stop valve 100 at the second pressure p₂, the pressure characteristic in the first section 241 and the second section 242 of the pressure line 240 is the same in both figures. When the pressure p₁ is reached at 7 bar, settling of the pressure p can be observed. This is attributable to the equalization of the pressure p in the entire pressure line 240. The pump 211 is then switched off 302. The pressure falls to the second pressure p₂, which is 3.5 bar. At this second pressure p₂, the stop valve 100 closes, as described above. The pressure characteristic in the first section 241, which is illustrated in FIG. 6a, now differs from the pressure characteristic in the second section 242 of the pressure line 240 in FIG. 6b. While the pressure p in the first section 241 falls to a third pressure p₃ of 1.5 bar, the pressure initially remains constant. In FIG. 6b, two cases are illustrated. On the one hand, the pressure p remains at a constant pressure pₖ after the second pressure p₂ is reached. On the other hand, a drop in the pressure p toward a pressure p_{L} can be seen. From this drop in the pressure p_{L}, a leak can be inferred, as described above.

1. A stop valve (100) comprising a magnet yoke (101), a solenoid coil (102), a compression spring (107), a guide (111, 122, 132), a guide pin (110, 120, 130), and a magnet armature (105), which is connected to the guide pin (110, 120, 130) and on which a flexible diaphragm (106) is arranged, wherein the diaphragm (106) is configured to be sealingly pressed onto at least one fluid connection (108, 109), and the compression spring (107) surrounds the solenoid coil (102).

2. The stop valve as claimed in claim 1, characterized in that the magnet armature is a flat armature or a plunger.

3. The stop valve (100) as claimed in claim 1, characterized in that the guide includes at least one guide bush (111) within the solenoid coil (102), and the guide pin (110) is inserted into said bush.

4. The stop valve (100) as claimed in claim 1, characterized in that the guide includes sliding bearing bushes (122), and the magnet armature (105) rubs along the sliding bearing bushes (122) and is supported by the guide pin (120).

5. The stop valve (100) as claimed in claim 1, characterized in that the guide includes a sliding bearing layer (132), and the magnet armature (105) rubs along the sliding bearing layer (132) and is supported by the guide pin (120).

6. The stop valve (100) as claimed in claim 1, wherein the stop valve (100) is configured to adopt the following modes:
a blocking mode, in which the diaphragm (106) closes both a fluid inlet (108) and a fluid outlet (109);
a metering mode, in which the stop valve (100) is opened hydraulically in a deenergized condition above a defined pressure; and
a reverse suction mode, in which a magnetic force between the magnet yoke (101) and the magnet armature (105) holds the stop valve (100) in an open position.

7. An SCR system (200), comprising a stop valve (100) as claimed in claim 1, a pump (211) and a metering module (230), which are connected together by a pressure line (240), wherein the stop valve (100) is arranged in the pressure line (140), and a pressure sensor (243) is arranged in the pressure line (240) between the stop valve (100) and the metering module (230).

8. A method for detecting leaks and/or identifying variations in metered amounts in an SCR (200) system as claimed in claim 7, wherein the stop valve (100) encloses a pressure (p) in the pressure line (240), the pressure (p) being monitored by the pressure sensor (243), comprising the following steps:
opening (300) the stop valve (100);
filling (301) the pressure line (240) with reducing agent;
closing (303) the stop valve (100);
lowering (304) a pressure (p) upstream of the stop valve (100) by shutting off (302) the pump (211); and
carrying out (305) leak detection and/or identification of variations in metered amounts by monitoring the pressure (p) downstream of the stop valve (100) by means of the pressure sensor (243).

9. The method as claimed in claim 8, characterized in that the stop valve (100) is closed by the spring force of the compression spring (107).

10. The method as claimed in claim 9, characterized in that a force which presses the diaphragm (106) against a fluid inlet (108) and a fluid outlet (109) is produced by the compression spring (107) when the pressure (p) upstream of the stop valve (100) is lowered (304).

11. The method as claimed in claim 8, characterized in that a first pressure (p₁) is built up in the SCR system (200) during the filling (301) of the pressure line (240) with reducing agent, the first pressure (p₁) is then reduced to a second pressure (p₂), at which the stop valve (100) is closed, and the pressure (p) upstream of the stop valve (100) is then lowered to a third pressure (p₃) by switching off (302) the pump (211).

12. The method as claimed in claim 8, characterized in that a drop in the enclosed pressure (p) downstream of the stop valve (100) is detected by the pressure sensor (243) over a defined time period in order to detect leaks.

13. The method as claimed in claim 8, characterized in that, after leakage detection and/or identification of variations in metered amounts, the pressure (p) upstream of the stop valve (100) is increased (306) to a fourth pressure (p₄) and the stop valve (100) is opened (307) when the fourth pressure (p₄) has been exceeded.

14. A non-transitory computer readable medium comprising program code to perform each step of the method as claimed in claim 8.

15. (canceled)

16. An electronic control device (260) which is configured to carry out leak detection and/or identification of variations in metered amounts by means of a method as claimed in claim 8.
